(19) United States
(12) Patent Application Publication
(10) Pub. No.: US 2015/0314723 A1
(43) Pub. Date: Nov. 5, 2015

(54) System and Device for Automatically Engaging Emergency Lighting

(71) Applicants: John Ghiata, Corona, CA (US); Lloyd Allnutt, Menifee, CA (US)

(72) Inventors: John Ghiata, Corona, CA (US); Lloyd Allnutt, Menifee, CA (US)

(21) Appl. No.: 14/462,267

(22) Filed: Aug. 18, 2014

Related U.S. Application Data
(60) Provisional application No. 61/986,397, filed on Apr. 30, 2014.

(51) Int. Cl. B60Q 1/46

(52) U.S. Cl. CPC B60Q 1/46

(57) ABSTRACT

Our invention comprises a software system and device for automatically engaging the existing warning lights (“4-way flashers”), Reverse lamps, Hazard lamps and Optional Additional lamps, in the event of serious vehicle collision. The software system described for enabling our invention is designed for implementation by automotive original equipment manufacturers (OEM). It is anticipated that car and truck manufacturers can simply plug our software component into the on-board computer to permit automatic engagement of emergency lighting in the event of collision or rollover. The code for our software is designed to operate on a real time operating system (RTOS) utilizing a fixed time step at a multiple of the processor clock speed.

### CROSS-REFERENCE

We claim priority to a provision patent application, No. 61/986,397, filed on Apr. 30, 2014.

### STATEMENT REGARDING FEDERAL SPONSORED RESEARCH

None.

### PARTIES TO JOINT RESEARCH AGREEMENT

None.

### REFERENCE TO “SEQUENCE LISTING”

Separately attached and incorporated by reference are CD-ROMs labeled Copy 1 and Copy 2.

### BACKGROUND OF INVENTION

In November 2007, more than 100 cars and trucks were involved in a daisy-chain of collisions on Highway 99, near Modesto, Calif.. The crashes were blamed on fog from the Tuolumne Valley. In February 2014, more than 100 cars and tractors were involved in crashes on the Turnpike near Bensalem, Pa. The accidents were blamed on icy conditions. Despite the seriousness of the crashes, few if any drivers had the presence of mind or the ability to manually engage their dashboard mounted four-way flashers to warn others of the hazardous situation.

Often those involved in a substantial crash, fail to manually engage the four-way flashers system, even though a hazard switch is conveniently located on the dashboard. The reasons for this failure may relate to inadvertence, lack of familiarity with the system, or worse, the driver/occupants may be disabled/unconscious or have left the portion of the roadway that is designed for travel. Automatically engaging the four-way flashers and related external lamps accomplishes the following: (1) warns other drivers that the vehicle has abruptly stopped so that they can avoid joining in the collision; (2) alerts others that the occupants may need assistance; and, (3) assists rescue workers in locating the occupants in the event the vehicle passes over an embankment or into a wooded or remote area.

Our invention operates by reliance on existing sensors in the vehicle bumpers and side panels. It requires no external modification of the lighting system. On sudden impact over 10 mph to front or rear bumpers, or at least 5 mph to the side panels, the on-board computer instructs the four-way flasher system which comprises the Reverse lamps, Hazard lamps and Optional Additional lamps, to engage automatically without flipping any switches. Electricity is stored in the system even with the vehicle ignition switched off. The sensors generate an activation signal to vehicle's computer which in turn causes the four-way flashers and other lamps to engage. Our invention can be installed directly to the vehicle's computer, allowing for seamless and automatic operation of the emergency lighting.

### SUMMARY OF INVENTION

The software system described in our invention is designed for implementation by automotive original equipment manufacturers (OEM). It is anticipated that car and truck manufacturers can simply plug our software component into the on-board computer to permit automatic engagement of emergency lighting or alternatively, incorporate the below described Code into existing OEM code.

The Code for our software is designed to operate on a real time operating system (RTOS) utilizing a fixed time step at a multiple of the processor clock speed. The Code is executed based on an interrupt at a whole number multiple of the controller base task rate (referred to as “task cycle”).

Our invention provides a computer driven method comprising a computer with software to electronically receive input of data from existing sensors in an automotive vehicle's bumpers and side panels, to interpret the said data and determine whether the vehicle has been involved in a crash; and on determination that the vehicle has been involved in a crash, to then automatically input an electronic signal to engage the Reverse lamps, Hazard lamps and Optional Additional lamps and causing all of the said lamps to blink more rapidly than a turn signal, thereby creating a strobe-like lighting effect.

In another embodiment, our invention provides for manual deactivation of Reverse lamps, Hazard lamps and Optional Additional lamps by switching the hazard switch off. In another embodiment, our invention provides a separate battery mounted in the vehicle which activates the Reverse lamps, Hazard lamps and Optional Additional lamps.

In order to determine that a crash or similar catastrophic event has occurred, our invention assumes that the vehicle is equipped with an embedded controller module that functions as the arbitrator of all vehicle crash related sensors (for instance, sudden impact or rollover). The said module is generally external to the embedded controller, where our Code resides, and the module controls deployment of safety features such as airbags, seatbelt tensioners, and other OEM components. The OEM is responsible for the determination of what constitutes a crash event. We suggest, an impact over 10 mph to front or rear bumpers, or at least 5 mph to the side panels, should be considered a crash event. Our invention relies on the determination of a crash event from the external controller module. It is common among OEM for the main output message of the external module to be referred to as “Crash” message. The “Crash” message generally is used to signal a safety related crash event requiring specific safety actions from all controllers on the vehicle. These safety related actions include disabling all fuel pumps, water pumps, power train drive components, the high voltage electrical system, and other devices as desired by OEM.

In the preferred embodiment of our invention, existing sensors cause the four-way flashers, Reverse lamps, Hazard lamps and Optional Additional lamps to engage, making the presence of a disabled vehicle more obvious to passers-by, alerting them to stay clear or to call/provide for assistance to those injured. The sensors from the bumpers or side panels send a message signal “Crash” to the computer processing unit (CPU), which in turn, sends a signal to the four-way flashers system, Reverse lamps, Hazard lamps and Optional Additional lamps. In this manner, simply re-programming the CPU by the OEM, will permit our invention to operate.

The signal causes the four-way flashers, Reverse lamps, Hazard lamps and Optional Additional lamps to blink more rapidly than a turn signal, creating a strobe-like lighting effect or an actual strobe light can be mounted on the vehicle within the location of the marker lights. In another embodiment, the four-way flashers, Reverse lamps, Hazard lamps and Optional Additional lamps can be manually deactivated by switching the hazard switch off. And in another embodiment, a separate battery, comprised of for instance, lithium-ion, is mounted in the vehicle which activates the four-way flashers, Reverse lamps, Hazard lamps and Optional Additional lamps in the event that battery power to the vehicle is lost or vehicle power was turned off.

Additionally, the invention is a plug-in device, such as a thumb-drive, disc or other compatible component which contains code for instructing a computer with software to electronically receive input of data from existing sensors in an automotive vehicle's bumpers and side panels, to interpret the said data and determine whether the vehicle has been involved in a crash; and on determination that the vehicle has been involved in a crash, to then automatically input an electronic signal to engage the Reverse lamps, Hazard lamps and Optional Additional lamps and causing all of the said lamps to blink more rapidly than a turn signal, thereby creating a strobe-like lighting effect.

### BRIEF DESCRIPTION OF DRAWINGS

FIG. 1 contains a logic flow chart of the Code used to automatically engage the emergency lighting. The logic is demonstrated in C Source Code for a generically embedded controller application.

FIG. 2 shows a typical location of the embedded Code within the OEM's total on-board computer code.

FIG. 3 contains a set of plots representing the simulation of a Crash message, and the actions implemented by the message

FIG. 4 is a top level representation of the Code, verifying the simulation.

### DETAILED DESCRIPTION OF DRAWINGS

The Code is integrated into an OEM body controller, or similar device, as an individually executing component. The OEM may determine the appropriate and exact location of the Code within its specific code architecture. The emergency lighting system contains approximately 4,000 lines of Code. The OEM will also be responsible for the final integrated code build that includes both its standard code as well as the Code included in this invention.

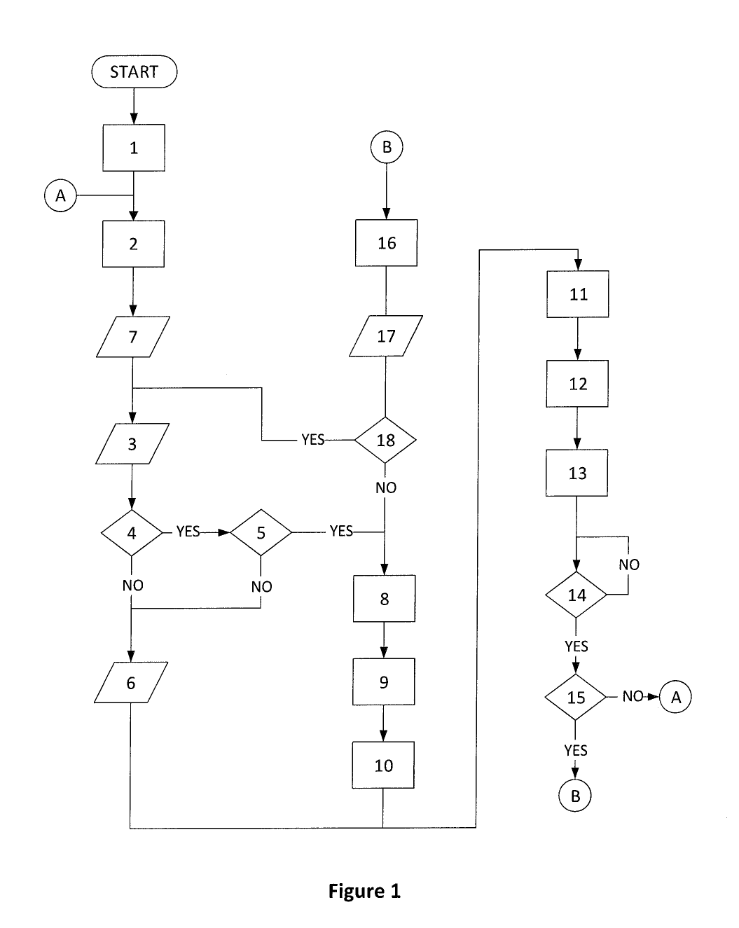

In FIG. 1, when installed by the OEM, the hardware for the emergency lighting is initialized with all variables set with initial values 1 so that outputs are driven to their initial states. The Pulse Timer 2 is set to zero milliseconds (ms), and the task cycle is set at 0 ms. The Code reads the OEM code interpreted value 7 for enabling Hazard lamps and interfaces with the OEM code. The Code for the computer program reads the current value of “Crash” 3 input signal. This is generally a CAN or FLEXRAY message read from one of the vehicle communication buses. The Code assumes that the CAN or FLEXRAY driver is embedded controller specific, and therefore it is assumed that once Code is built for a specific processor target, the low-level message handling will then be added to output both the “Crash” signal value as well as an indication if a new message is present within a task cycle or sample time.

For convenience and to follow the logic flow, the circle symbols contain the letters “A” and “B.” This means that logic flows either along the A-to-A path or the B-to-B path depending on detection of crash event.

The Code is set to make a Decision 4 asking if the “Crash” message is present on the communication bus for the required sample times, for instance, an embodiment of “Crash” needs to be as follows:

a. present for a group of three consecutive messages at 10 ms apart;

b. with a 200 ms break; and

c. present for a group of three consecutive messages at 10 ms apart.

If the Decision 4 asking if the “Crash” message is “Yes,” then the correct value on the communication bus for the required sample times, for instance, an embodiment of “Crash” message needs to be as follows to trigger the next Decision 5 as “Yes:”

a. greater than 1 for a group of three consecutive messages at 10 ms apart;

b. with a 200 ms break; and

c. equal to zero for a group of three consecutive messages at 10 ms apart.

The Code then enables the pulse generator logic for Reverse lamps 8. The Code will look a the value of the Pulse Timer and compare it with the calibrated profile of Pulse Value versus the Pulse Time. The profile can be OEM or vehicle specific and will be determined by the OEM, and applicable governmental regulations. Output from this logic is in Boolean value of “off” or “on” for a given task cycle.

The Code next enables pulse generator for the Hazard lamps 9, and overwrites the value read from the interpreted value 7 for enabling Hazard lamps and for interface with the OEM code 17. The Code will look at the value of the Pulse Timer and compare it with the calibrated profile of Pulse Value versus Pulse Time. The profile can be OEM or vehicle specific and will be determined by the OEM and applicable governmental regulations. Output from this logic is in Boolean value of “off” or “on” for a given task cycle.

The Code sends an enable signal to the pulse generator for Optional Additional lamps 10. The Code will look at the value of the Pulse Timer and compare it with the calibrated profile of Pulse Value versus Pulse Time. The profile can be OEM or vehicle specific and will be determined by the OEM and applicable governmental regulations. Output from this logic is in Boolean value of “off” or “on” for a given task cycle.

The Code submits an enable signal to Reverse lamps 11. This is a switched “on” or “off” signal equal to the output at Reverse lamps 8. This Boolean value is written to the controller output driver. This driver is embedded controller specific, and therefore it is assumed that once Code is built for a specific processor target, the low-level message handling will then be added. The Code sends an enable signal to the Hazard lamps 12. This is a switched “on” or “off” signal equal to the output at Hazard lamps 9. This Boolean value is written to the controller output driver. This driver is embedded controller specific, and therefore it is assumed that once Code is built for a specific processor target, the low-level message handling will then be added.

The Code submits an enable signal to Optional Additional lamps 13. This is a switched “on” or “off” signal equal to the output at Optional Additional lamps 10, and it is “off” if the path of logic does not flow through it. This Boolean value is written to the controller output driver. This driver is embedded controller specific, and therefore it is assumed that once Code is built for a specific processor target, the low-level message handling will then be added.

A decision asks if the elapsed task cycle time is equal to the time step value allocated to complete the total logic 14. If “Yes,” then the decision 15 asks if Reverse lamps 8, were executed in the present task cycle. And, the Pulse Time is re-set 16 to previous task cycle value at 0 ms.

If the Decision 4 asking if the “Crash” message is “No,” then the code interpreted value 6 for enabling Reverse lamps 8 interfaces with the OEM code.

If the Decision 5 asking if the “Crash” message is “No,” then the code interpreted value 6 for enabling Reverse lamps interfaces with the OEM code.

The Code reads the OEM code interpreted value for enabling Hazard lamps by interfacing with the OEM code 17. Output from the OEM code logic is a Boolean value of “on” or “off” for a given task cycle. A Decision 18 is made if “falling edge” is sensed at interpreted value 7 for enabling Hazard lamps interfaces with the OEM code. A “falling edge” is defined as an “off” in the present task cycle and “on” in the previous task cycle.

If the Decision at 14 is “No,” then the Decision is repeated until the Decision becomes “Yes.”

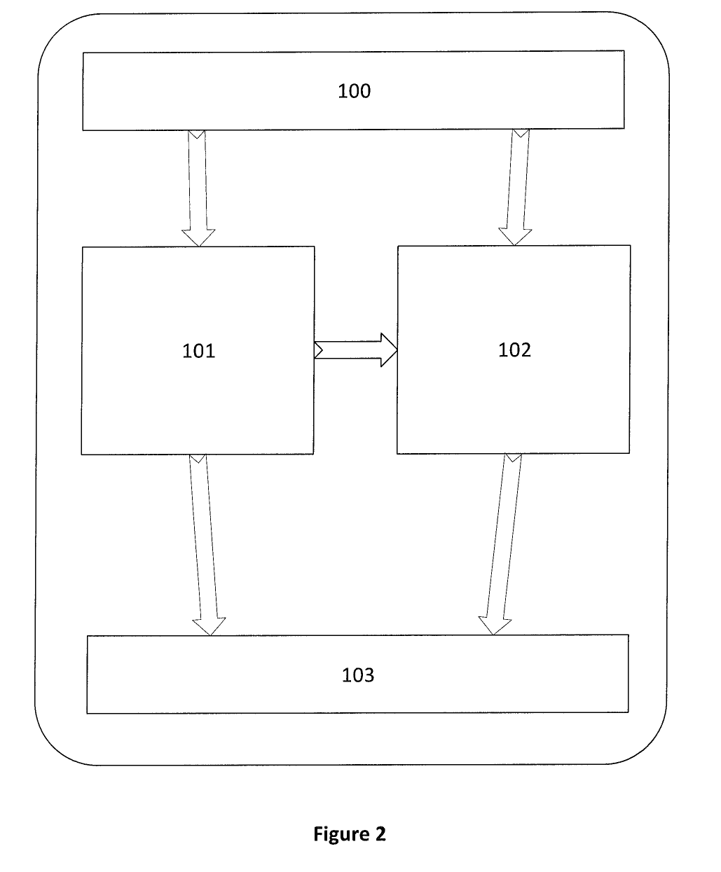

In FIG. 2, the OEM embedded controller input processing and drivers is depicted 100. The OEM logic software 101 is shown. This invention's Code software component 102 is part of the overall code architecture. The OEM embedded controller output processing and drivers 103 are shown.

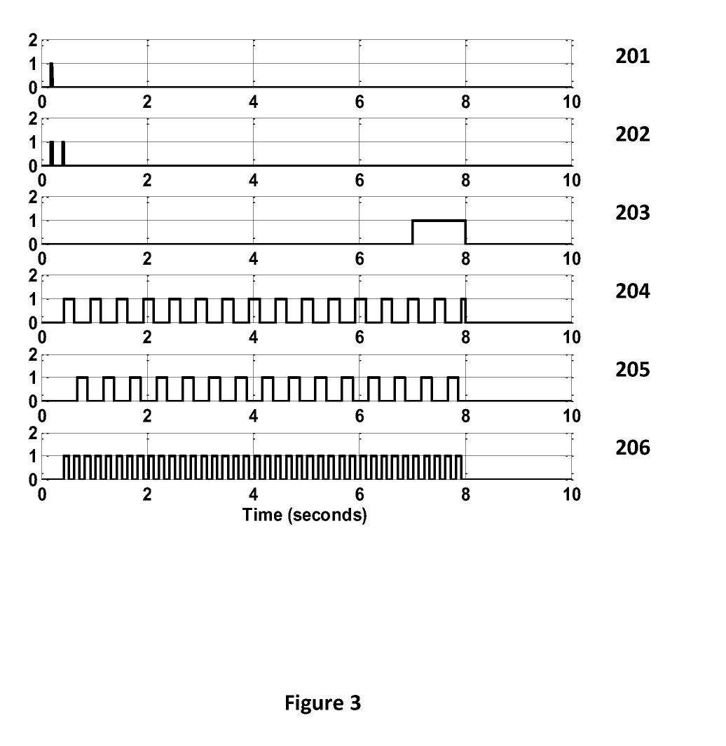

In FIG. 3, a set of plots shows the verified simulation of the Code. The “Crash” message 201 is read within the first 0.5 seconds in the simulation. The “Crash Present” is determined 202. It can be seen that the emergency lighting for Reverse, Hazard and Optional Additional lamps is initiated as soon as the Code determines the Crash event is valid. The Reverse 205, Hazard 204, and Optional Additional 206 lamps begin pulsing between “on” and “off” (as represented by the Boolean 1 and 0, respectively). The pulse frequency and characteristics are easily modifiable to whatever an OEM would prefer, but are displayed here in default characteristics for illustration purposes. At 7 seconds into the simulation, the “Hazard switch” 203 is sensed being first manually turned “on,” then 1 second later, being turned “off” The Code registers the “off” event and stops the emergency function, just per the logic description above.

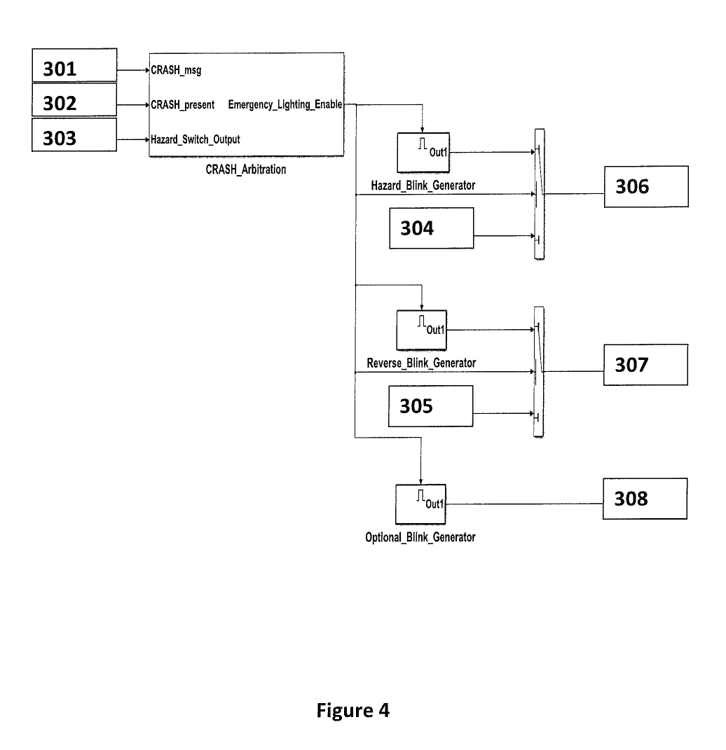

In FIG. 4, a verified simulation of the Code is provided. Each block represents a system of sub-systems that enables the logic described in FIG. 1. Flow and functionality have been verified at the Simulink™ level in a computer simulation. The verified simulation is then translated into ASCII format C/C++ source code that is submitted as part of this invention. Inputs for the invention logic are the “Crash” message values 301, “Crash Present” message arbitration 302, and the Hazard switch 303. The inputs received from the standard vehicle controller's actions are Hazard command 304, Reverse command 305, outputs for the logic are Hazard lamps enable signal 306, Reverse lamps enable signal 307, and Optional Additional lamps enable 308.

The above description of the preferred embodiment of the present invention has been presented for the purposes of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims.

### SEQUENCE LISTING

Machine format:

IBM-PC

Operating system compatibility:
MS-DOS, MS-Windows

File List:
The C/C++ source code contained on the currently transmitted disc was generated using the Matlab 2014a development environment. The intent of the source code is to be used for development on a generic 32-bit embedded processor.

All files under the heading Patent Specific Code contain the code information specific to the invention described in the patent. All files under the heading Supporting Code contain the code information that allow the code to be used in a generic development environment outside of Matlab 2014a and are not specific to this patent.

| File | Size | Date Created |
|---|---|---|
| Patent Specific Code: | | |
| Ghiata_Allnut_Patent_v01_00.c | 17 KB | 3 Aug. 2014 |
| Ghiata_Allnut_Patent_v01_00.h | 6 KB | 3 Aug. 2014 |
| Ghiata_Allnut_Patent_v01_00_private.h | 1 KB | 3 Aug. 2014 |
| Ghiata_Allnut_Patent_v01_00_types.h | 1 KB | 3 Aug. 2014 |
| multiword_types.h | 17 KB | 3 Aug. 2014 |
| rtmodel.h | 1 KB | 3 Aug. 2014 |
| rtwtypes.h | 1 KB | 3 Aug. 2014 |
| Supporting Code: | | |
| rtwcontinuous.h | 5 KB | 27 Dec. 2013 |
| rtw_extmode.h | 4 KB | 27 Dec. 2013 |
| rtw_matlogging.h | 7 KB | 27 Dec. 2013 |
| rtw_solver.h | 9 KB | 27 Dec. 2013 |
| simstruc_types.h | 8 KB | 27 Dec. 2013 |
| sl_sample_time_defs.h | 3 KB | 27 Dec. 2013 |
| sl_types_def.h | 2 KB | 27 Dec. 2013 |
| sysran_types.h | 6 KB | 27 Dec. 2013 |
| tmwtypes.h | 22 KB | 27 Dec. 2013 |
| rt_logging.h | 12 KB | 3 Jan. 2014 |
| rt_main.c | 13 KB | 8 Nov. 2013 |
| ext_work.h | 5 KB | 8 Nov. 2012 |

We claim:

1. A computer driven method comprising a computer with software to electronically receive input of data from existing sensors in an automotive vehicle's bumpers and side panels, to interpret the said data and determine whether the vehicle has been involved in a crash;
and on determination that the vehicle has been involved in a crash, to then automatically input an electronic signal to engage the Reverse lamps, Hazard lamps and Optional Additional lamps and causing all of the said lamps to blink more rapidly than a turn signal, thereby creating a strobe-like lighting effect.

2. The method of claim 1, where Reverse lamps, Hazard lamps and Optional Additional lamps can be manually deactivated by switching the hazard switch off.

3. The method of claim 1, where a separate battery is mounted in the vehicle which activates the Reverse lamps, Hazard lamps and Optional Additional lamps.

4. A plug-in device containing code to instruct a computer with software to electronically receive input of data from existing sensors in an automotive vehicle's bumpers and side panels, to interpret the said data and determine whether the vehicle has been involved in a crash;
and on determination that the vehicle has been involved in a crash, to then automatically input an electronic signal to engage the Reverse lamps, Hazard lamps and Optional Additional lamps and causing all of the said lamps to blink more rapidly than a turn signal, thereby creating a strobe-like lighting effect.

5. The device of claim 4, where Reverse lamps, Hazard lamps and Optional Additional lamps can be manually deactivated by switching the hazard switch off.

6. The device of claim 4, where a separate battery is mounted in the vehicle which activates the Reverse lamps, Hazard lamps and Optional Additional lamps.
